(19) United States
(12) Patent Application Publication
(10) Pub. No.: US 2015/0377277 A1
(43) Pub. Date: Dec. 31, 2015

(54) PRESS-ON TYPE CLIP RETAINER

(71) Applicant: Ramco Specialties, Inc., Hudson, OH (US)

(72) Inventors: Gerald P. Downey, Sterling Heights, MI (US); Daniel B. Donovan, Macomb, MI (US); Mark S. Boyer, South Lyon, MI (US)

(21) Appl. No.: 14/751,798

(22) Filed: Jun. 26, 2015

Related U.S. Application Data
(60) Provisional application No. 62/018,980, filed on Jun. 30, 2014.

(51) Int. Cl. F16B 39/24

(52) U.S. Cl. CPC F16B 39/24

(57) ABSTRACT

A press-on clip retainer includes a base member and a plurality of tab members extending form the base member. The base member includes a hub portion, blade members, and defines a plane P and an opening, wherein the opening allows for selective passage of an associated fastener through the hub portion. The tab members are circumferentially disposed around the opening to form a channel to receive the fastener in the channel and through the opening along a longitudinal axis L. Each tab member includes on a proximal end thereof, a wedge portion provided inwardly directed relative to the longitudinal axis L. An affixing portion is provided on the distal end of each tab member, the affixing portion being disposed substantially in parallel with the longitudinal axis L, wherein a free end of the affixing portion is directed towards the hub portion and engaging members project inwardly from the affixing portion.

### CROSS REFERENCE TO RELATED APPLICATIONS

This application claims benefit to U.S. Provisional Patent Application Ser. No. 62/018,980 filed on Jun. 30, 2014, the contents of which are incorporated herein by reference.

### TECHNICAL FIELD

The present disclosure relates generally to clip retainers and, in particular, to press-on thread cage clip retainers which can be installed by pushing the clip retainer onto an associated threaded or grooved stud for selectively coupling one or more associated members such as associated panel members relative to the stud by holding the panels between the retainer and the stud. The subject press-on thread clip retainer is easily and quickly inserted onto, yet securely retained around, the threaded or grooved stud thereby preventing the retainer from being pulled off of the threaded stud. The clip retainer may also be selectively twisted off from the stud thereby enabling the fastener retainer to be removed as may be desired.

### BACKGROUND

In many applications it is necessary to secure together one or more members, such as panels, plates or other members, in a fastened yet selectively releasable manner relative to an associated base member or the like. For example, vehicle body members typically include panels that must be fastened securely to the vehicle, but must also be selectively removable from each other for reasons such as for servicing of the vehicle. For example, a central undercarriage panel member of an automobile covering the underside of the engine compartment may need to be fastened relative to one or more surrounding panel members, while being selectively removable relative to those panel members for reasons including to provide access for servicing of the associated vehicle or the like.

Many different types of releasable fasteners have been developed for this type of application. However, there is a need to reduce cost, without sacrificing quality or performance. In automotive applications, one strategy for reducing costs is to reduce production time. According to this strategy, special purpose clips are specified for securing various components throughout the interior and exterior of the vehicle, rather than traditional fasteners such as screws, bolts, nuts, or the like. Although screws, bolts, nuts, or the like are generally inexpensive to manufacture, each bolt typically requires a nut and/or washer during assembly and the time required for assembly personnel or machinery to install fastener sets of this type is sometimes excessive. The special purpose clips substituted for traditional fasteners often require the use of power tools for installation owing in part to the force required to seal the clips into place.

As a result, there is a need for a simple but robust press-on type clip retainer that can be quickly inserted with an ultra-low exertion force, yet securely retained onto, a threaded stud. Such a retainer should simulate a nut, and require a twisting action for removal, but should also advantageously eliminate the time required to secure a conventional bolt, nut, and washer combination into position and should also not require the use of power tools for installation.

### SUMMARY

The following presents a simplified overview of the example embodiments in order to provide a basic understanding of some aspects of the example embodiments. This overview is not an extensive overview of the example embodiments, and is intended to neither identify key or critical elements of the example embodiments nor delineate the scope of the appended claims. Its sole purpose is to present some concepts of the example embodiments in a simplified form as a prelude to the more detailed description that is presented later.

In accordance with embodiments herein, a press-on type clip retainer apparatus is provided for releasably connecting one or more associated members to an associated base or other member or foundation requiring only an ultra-low exertion force and without the need for the use of power tools for installation. In one embodiment the clip retainer apparatus is configured for use in connecting associated first and second panel members each having, respectively, opposite front and rear surfaces to selectively couple the panel members in a stacked relationship with the front surface of the first panel facing the rear surface of the second panel.

Overall, the press-on clip retainer of the example embodiment includes a base member and a plurality of tab members extending from the base member. The base member includes a hub portion, blade members, and a plurality of tab support members. Further, the base member defines a plane P and an opening, wherein the opening allows for selective passage of an associated fastener through the hub portion. In the example embodiment, each of the plurality of tab members is carried on a rolled junction member extending from a corresponding one of the plurality of tab support members formed by the base member. The plurality of tab members are circumferentially disposed around the opening to form a channel to receive the associated threaded fastener in the channel and through the opening along a longitudinal axis L. Each tab member includes opposite proximal and distal ends. A wedge portion is provided on the proximal ends of the tab members. The wedge portions are inwardly directed relative to the longitudinal axis L and are oriented forming an acute angle of about 45° relative to the plane P of the base member. An affixing portion is provided on the distal end of each tab member. The affixing portion is disposed substantially in parallel with the longitudinal axis L, wherein a free end of the affixing portion is directed towards the hub portion. Further in the example embodiment, each tab member includes, on the affixing portion thereof, at least one engaging member that projects inwardly relative to the longitudinal axis L. Free edges of the engaging members are configured to lockingly engage with the threads or grooves of the associated stud member for securing the clip retainer with the stud.

For reasons that will become apparent based on the descriptions below, the press-on clip retainer of the example embodiment includes at least two (2), but preferably three (3) or more tab members extending from the base member and being circumferentially disposed around the opening forming the channel configured to selectively receive the associated threaded fastener. In the example embodiment, each tab member mutually cooperates with the one or more other tab members for easily receiving the associated stud when inserted between the tab members in an insertion direction, but securely capturing the associated stud against a force in a withdrawal direction opposite the insertion direction. The arrangement and configuration of the tab members essentially generate a collective inwardly directed pinching force that resists against the force of the associated stud in the withdrawal direction.

Also in the example embodiment, the blade members and the tab supports extend outwardly from the hub portion relative to the longitudinal axis L.

Still further in the example embodiment, the tab support members are positioned between the blade members.

Yet still further in the example embodiment, wherein rolled junction members are interposed between the tab support members and the tab members.

### BRIEF DESCRIPTION OF THE DRAWINGS

The foregoing and other features of the embodiments herein will become apparent to those skilled in the art to which the present spring clip apparatus relates upon reading the following description with reference to the accompanying drawings, in which:

FIG. 1 is a top perspective view of a press-on type clip retainer apparatus in accordance with the example embodiment;

FIG. 2 is a top plan view of the press-on type clip retainer apparatus of FIG. 1 in accordance with the example embodiment;

FIG. 3 is a side elevational view of the press-on type clip retainer apparatus of FIG. 1 in accordance with the example embodiment taken along line 3-3 of FIG. 2;

FIG. 4 is a cross-sectional view of the press-on type clip retainer apparatus of FIG. 1 taken along line 4-4 of FIG. 2;

FIG. 5 is a cross-sectional view of the press-on type clip retainer apparatus of FIG. 1 taken along line 5-5 of FIG. 2;

FIG. 6 is a side elevational view of the press-on type clip retainer apparatus of FIG. 1 taken along line 6-6 of FIG. 4;

FIG. 7 is a bottom perspective view of the press-on type clip retainer apparatus of FIG. 1 in accordance with the example embodiment;

FIG. 8 is an enlarged cross-sectional view of a portion of the press-on type clip retainer apparatus shown in FIG. 4 illustrated in operative position relative to an associated stud member in accordance with the example embodiment;

FIG. 9 is an exploded, fragmented, perspective view of the press-on type clip retainer apparatus of FIG. 1 shown with the mating surfaces and an associated threaded fastener;

FIG. 10 in an unassembled conformation is a cross-sectional view taken substantially along line 10-10 of FIG. 9; and

FIG. 11 is a sectional view taken substantially along line 10-10 of FIG. 9, but showing the components assembled together.

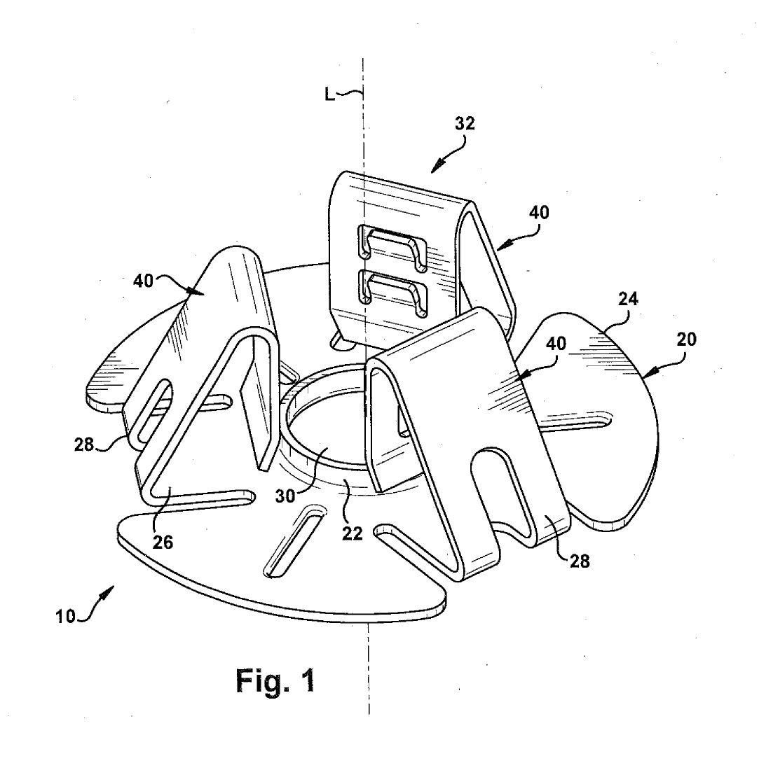

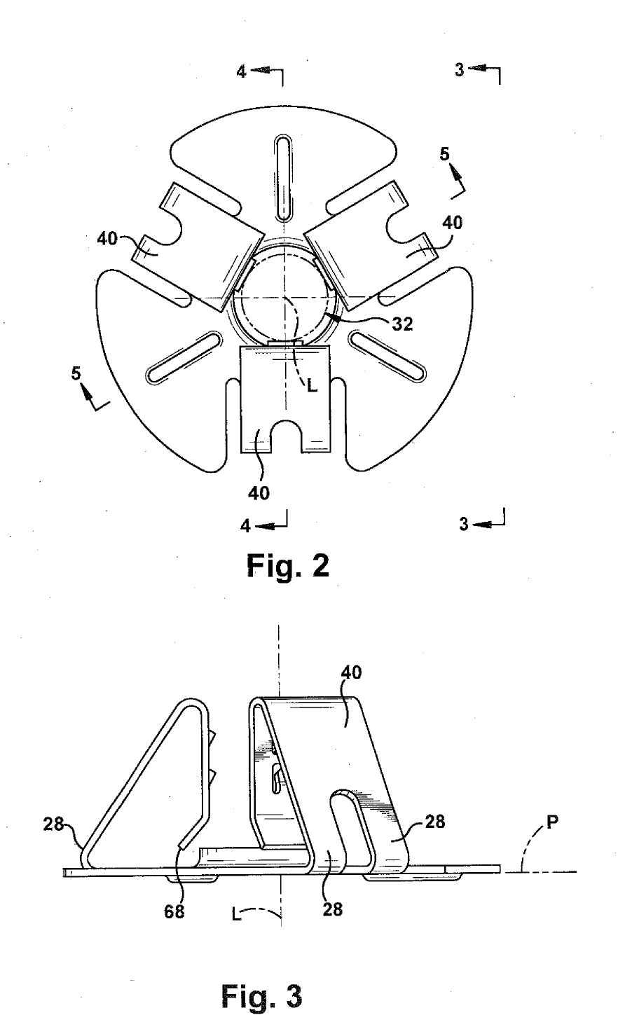

### DETAILED DESCRIPTION OF EXAMPLE EMBODIMENTS

With reference now to the drawing Figures, wherein the showings are for purposes of describing an example embodiment only and not for purposes of limiting same, the example embodiments of the invention claimed herein relate to a press-on type clip retainer apparatus for selectively releasably securing associated one or more first members with a grooved stud, threaded member or other elongate member of an associated base or foundation member.

A press-on type clip retainer apparatus in accordance with the present invention is generally indicated by the numeral 10. In the example embodiment illustrated, the press-on type clip retainer apparatus 10 is of unitary construction, formed as a single body from a metal material by conventional manufacturing techniques such as cutting, stamping and forming the metal into the shape illustrated. The clip retainer may also be formed of plastic by conventional manufacturing methods such as injection molding. However, other materials such as highly specialized application-specific materials may be utilized wherein the press-on type clip retainer apparatus of the example embodiment is formed by corresponding suitable one or more manufacturing techniques.

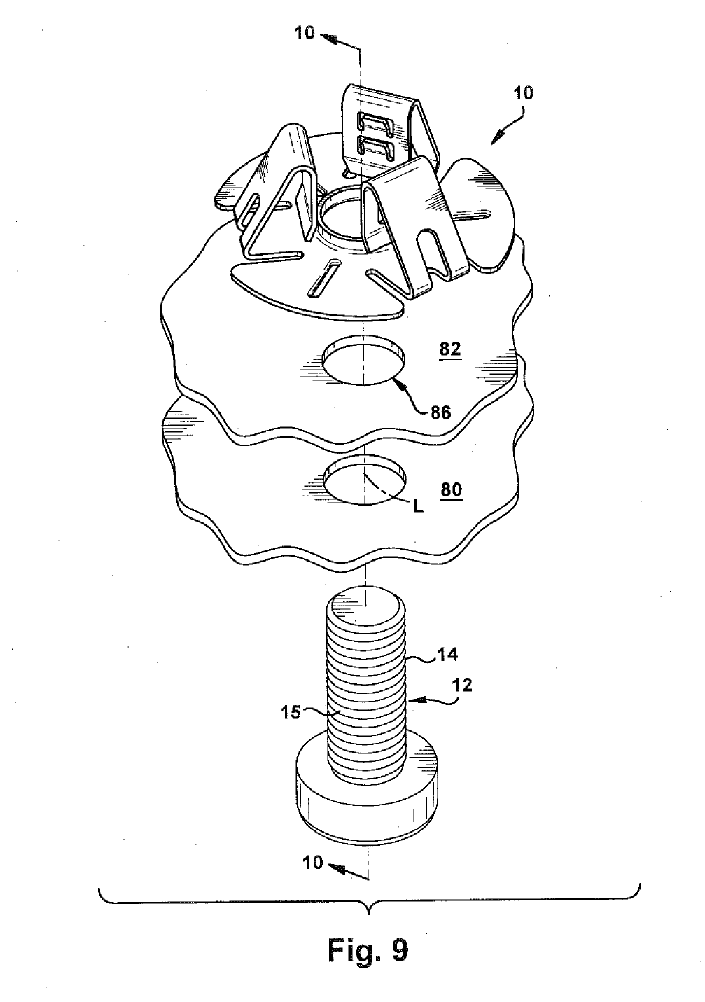

The press-on type clip retainer apparatus 10 of the example embodiment is generally configured to have a base member 20 and a series of inverted V-shaped tab members 40. The base member 20 includes central hub portion 22, blade members 24, and tab support members 26. The central hub portion 22 of the base member 20 defines an opening 30 through the base member, which is located concentrically thereof. In the example embodiment illustrated, the blade members 24 and tab support members 26 extend radially outwardly from the central hub portion 22, and the tab support members 26 are positioned between the blade members 24. During use of the subject press-on type clip retainer apparatus 10 of the example embodiment, the base member 20 serves to bear against a flat surface of an associated structure to which the retainer apparatus 10 selectively secures onto an associated fastener 12 (FIGS. 9-11) such as an associated threaded or grooved stud 14, or the like. For this reason, preferably, the base member 20 of the subject press-on type clip retainer apparatus 10 is generally planar defining a plane P (FIGS. 3-5) in accordance with the example embodiment illustrated. The opening 30 and tab members 40 define, generally, a longitudinal axis L of the subject clip retainer apparatus 10.

Each of the plurality of inverted V-shaped tab members 40 includes opposite proximal and distal ends 50, 60, wherein each of the plurality of tab members is carried by a corresponding rolled junction member 28 coupling the proximal end 50 of each of the tab members 40 with a corresponding tab support member 26. In the example embodiment illustrated, each of the plurality of inverted V-shaped tab members 40 includes a wedge portion 52 on the proximal end thereof, and an affixing portion 62 on the distal end thereof. As shown, the wedge portions 52 of each of the plurality of tab members 40 are inwardly directed from the rolled junction members 28 relative to the longitudinal axis L. Further as shown, the affixing portions 62 of each of the plurality of tab members 40 are disposed in an orientation to extend substantially in parallel with the longitudinal axis L.

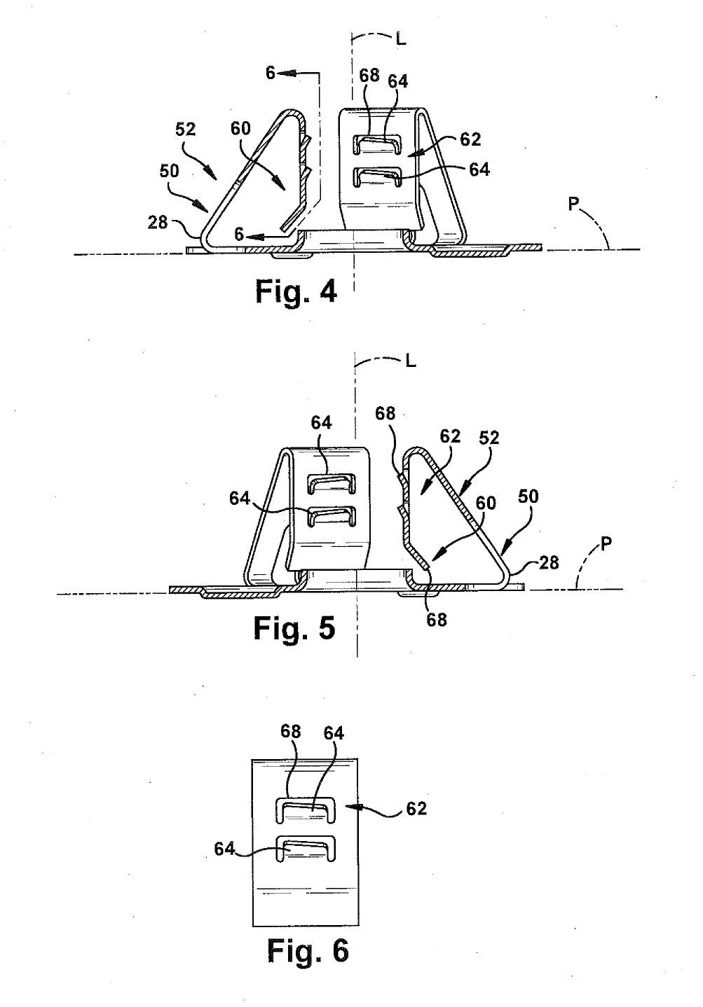

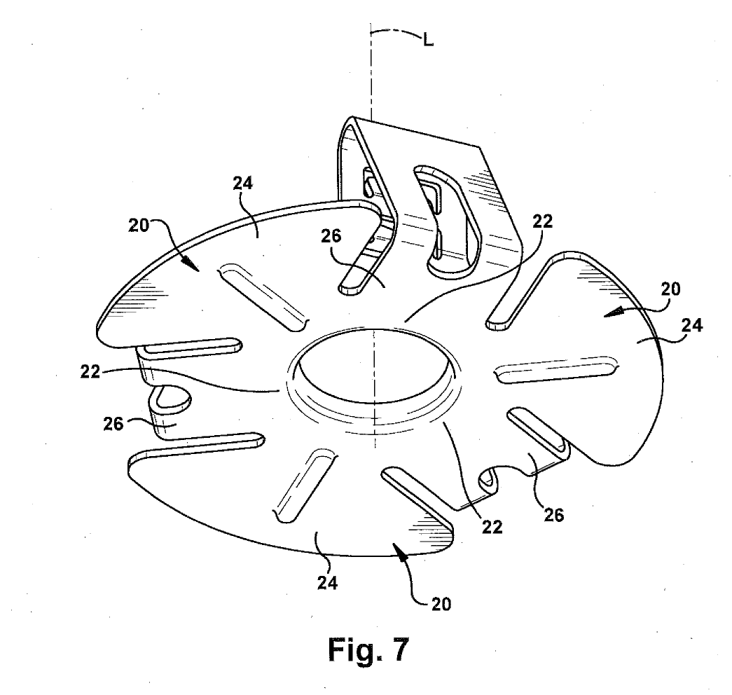

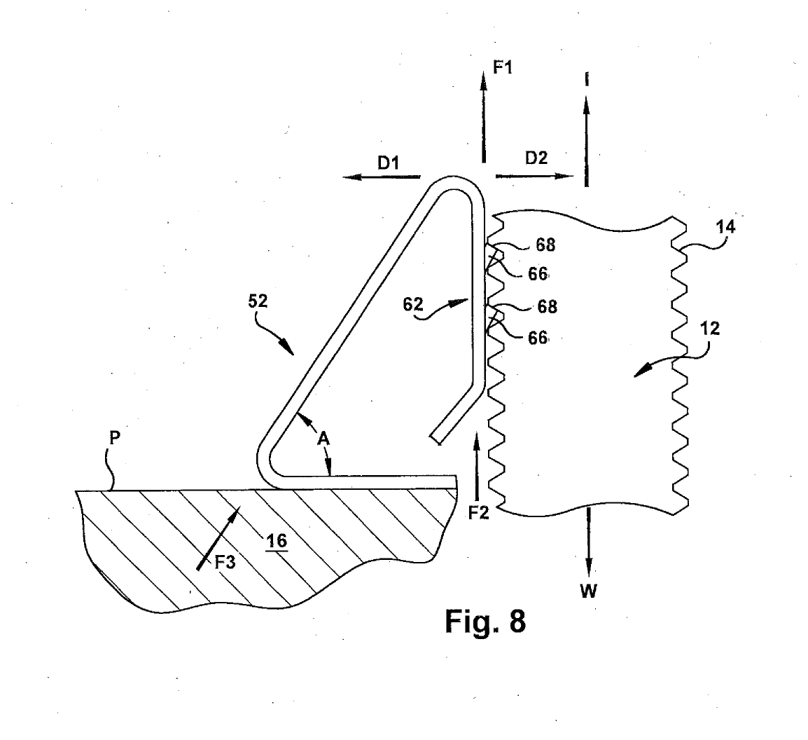

In accordance with the example embodiment, the tab members 40 are generally flat in overall shape thereby simplifying the manufacture thereof. In addition, the tab members 40 are circumferentially arranged about the opening 30 to form a channel 32 that receives an associated threaded or grooved stud 14. For interfacing with the associated threaded or grooved stud 14, each the tab member 40 includes on the affixing portion 62 thereof at least one engaging member 64 that projects inwardly from the affixing portion 62 relative to the longitudinal axis L. The engaging members 64 are provided in the example embodiment in the form of thread-interfacing barbs 66 (FIG. 8) disposed axially one above the other on the inside surfaces of each affixing portion 62. Barbs 66 may be formed as perforations in the affixing portions 62 bent inwardly therefrom to form wedge-like shapes having flat distal ends 68 that extend for a portion along the flat inwardly directed face of each affixing portion 62. The far distal ends of the tab members 40 are bent outwardly relative to the opening 30 as best shown in FIGS. 4 and 5 to assist in guiding the lead end of the associated fastener 12 (FIGS. 8-11) into the region between the engaging members 64. The four distal ends define flat ends 68 similar to the flat ends of the barbs 66.

Further in accordance with the example embodiment, the blade members 24 and the tab support members 26 extend radially outwardly from the central hub portion 22 relative to the longitudinal axis L. Also, the tab support members 26 are positioned between the blade members 24, and the rolled junction members 28 are interposed between the tab support members 26 and the tab members 40.

FIG. 8 is a cross sectional illustration of a portion of the press-on type clip retainer apparatus 10 of the example embodiment showing the engaging members 64 of one of the tab members 40 engaging an associated grooved fastener 12 in the form of a threaded stud 14. Essentially, as described, the clip retainer apparatus 10 and the associated grooved fastener 12 mutually engage by relative motion therebetween. In practice, a loose retainer apparatus 10 is typically positioned over and onto an immobilized or otherwise stationary threaded stud 14 whereby the stud 14 is received within and through the channel 32. However, for purposes of describing an advantageous benefit flowing from the structure of the subject clip retainer 10, it will be assumed with reference to FIG. 8 that the clip retainer 10 rests stably against an associated base 16 and that the associated fastener 12 is inserted into the channel 32 in an insertion direction I. During insertion of the associated fastener 12 into the channel 32, the tab members 40 flex in a first direction D1 outwardly relative to the longitudinal axis of the clip retainer extending along the channel. Once seated, the engaging members 64 hold the associated fastener 12 fixed against a withdrawing force in a withdrawing direction W.

During use, a withdrawing force in the withdrawing direction W generates a first overall resisting force F1 having a parallel force component F2 extending along each affixing portion 62 of the tab members 40, and an oblique force component F3 extending along the wedge portion 52. Attempts to pull the associated fastener 12 in the withdrawal direction W relative to the base 16 generate the component forces F1, F2 and F3 in each of the tab members 40. In the example embodiment, the subject slip retainer 10 comprises at least two (2) and preferably three (3) tab members 40 wherein the resistive oblique component forces F3 of each of the tab members 40 cooperatively bias or otherwise urge the tab members 40 in a clamping direction D2 inwardly relative to the longitudinal axis L. The tab members 40 are essentially permitted to flex slightly inwardly at the rolled junction members 28 during attempts to pull the associated fastener in the withdrawal direction W which provide a hinge-like function thereby enabling the portions 52 of the tab member 40 to provide a wedge function to firmly hold the associated fastener by collectively pinching the fastener therebetween. In this way, in accordance with the example embodiment, a component of any force which would otherwise be used in withdrawing the fastener 12 from the channel 32 is used by the unique arrangement of the wedge portions 52 relative to the affixing portions 62 to cause the tab members 40 and the engaging members 64 carried thereon to be urged into additional or further clamping relationship. In the example embodiment, the wedge portions 53 define an acute angle A relative the plane P. In a particular example embodiment, the wedge portions 53 define an acute angle A of about 45° relative the plane P.

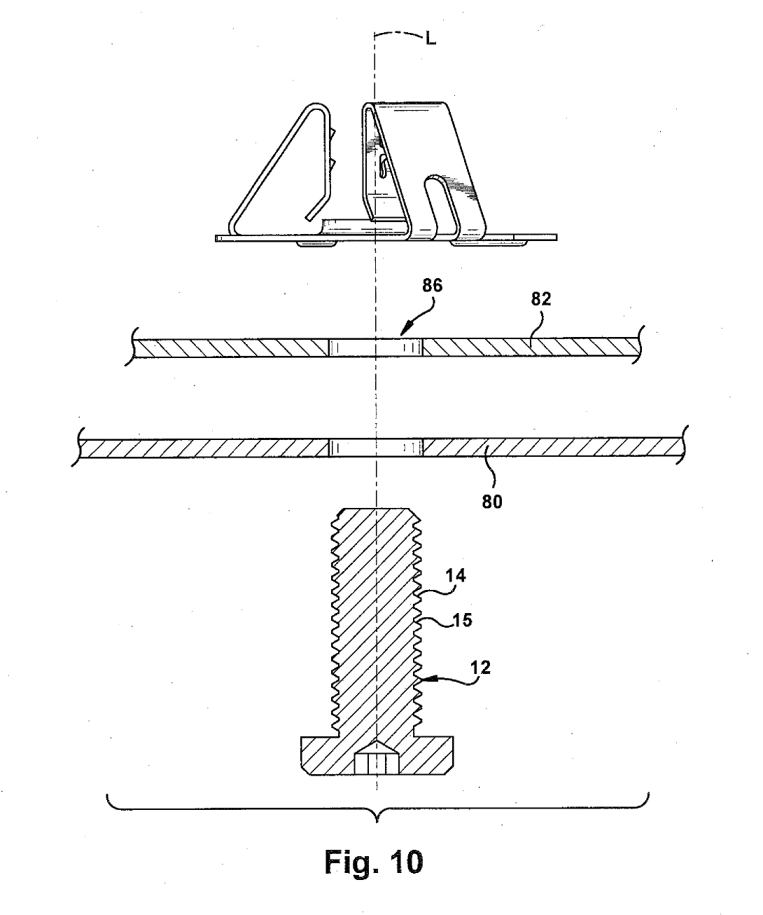

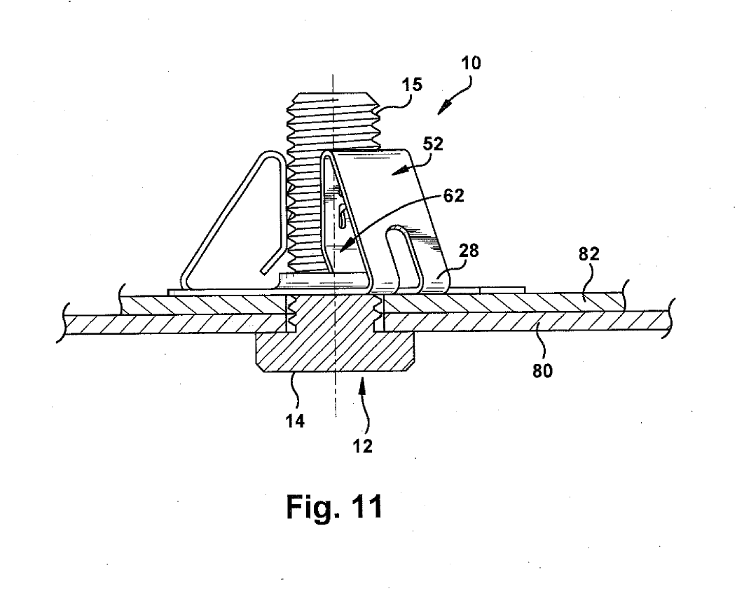

As seen in FIGS. 10-11, a clip cage retainer 10 can be used to secure a wall structure 80 and an overlapping structure 82 together. For example, the overlapping structure 82 could be heat shields or wire/hose clamps, and the wall structure 80 could be the surfaces inside the engine compartment of an automobile. Wall structure 80 is provided with a threaded stud 14 having threads 15, and the overlapping structure 82 includes a hole 86. The overlapping structure 82 can be positioned against the wall structure 80 such that the hole 86 surrounds the threaded stud 14. Clip retainer 10 can be pushed onto the threaded stud 14 to affix overlapping structure 82 to the wall structure 80. It is the arrangement of barbs 66, the collective wedge shape and inherent spring nature of the set of V-shaped tabs 40 that provides for the push-on and twist-off nature of clip retainer 10 of the example embodiment.

To install clip retainer 10, threaded stud is positioned in retainer opening 32 such as by moving the retainer adjacent to the stud. The clip retainer 10 is then pushed downwardly at blade members 24 causing leg portions 40 to slide over and contact the associated threaded stud 14. Barbs 66 do not resist movement of clip retainer 10 in the direction of insertion I because as leg portions 40 are installed onto threaded stud 14, the interaction between threads 15 and the wedge-like shape of barbs 66 cause leg portions 40 to further expand in the first direction D1 (FIG. 8) relative to the longitudinal axis L. Such expansion allows barbs 66 to slide over threads 45 as clip retainer 40 is installed onto threaded stud 14.

Once installed in the manner described above, the barbs 66 prevent thread clip retainer 40 from being pulled off of threaded stud 14 because distal ends 68 of barbs 66 engage threads 15 of stud 14. As such, distal ends 68 of barbs 66 simulate threads of a nut, and prevent the retainer 40 from being pulled off of threaded stud 14. As should be appreciated, twisting the retainer 40 counterclockwise will remove the retainer 40 from threaded stud 14. A set of pliers or manually turning the retainer 40 can effect such removal.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

Having thus described the embodiments, it is now claimed:

1. A press-on clip retainer (10) adapted to receive an associated threaded fastener, the retainer comprising:
a base member (20) having a hub portion (22), blade members (24), and a plurality of tab support members (26), the base member (20) defining a plane P and an opening (30), the opening (30) allowing for selective passage of an associated fastener (12) through the hub portion (22); and
a plurality of tab members (40), each of the a plurality of tab members (40) being carried on a rolled junction member (28) extending from a corresponding one of the plurality of tab support members (26) of the base member (20), the plurality of tab members (40) being circumferentially disposed around the opening (30) to form a channel (32) to receive the associated threaded fastener (12) in the channel (32) and through the opening (30) along a longitudinal axis L;
wherein each tab member (40) includes on a proximal end (50) thereof a wedge portion (52) inwardly directed relative to the longitudinal axis L, and on a distal end (60) thereof an affixing portion (62) disposed substantially in parallel with the longitudinal axis L, a free end (63) of the affixing portion (62) being directed towards the hub portion (22), and;
wherein each the tab member (40) includes on the affixing portion (62) thereof at least one engaging member (64) that projects inwardly relative to the longitudinal axis L;
wherein the blade members (24) and the tab support members (26) extend radially outwardly from the hub portion (22) relative to the longitudinal axis L;
wherein the tab support members (26) are positioned between the blade members (24);
wherein the rolled junction members (28) are interposed between the tab support members (26) and the tab members (40).

2. The press-on clip retainer (10) according to claim 1, wherein:
the wedge portion (52) of each tab member (40) and a corresponding one of the plurality of tab support members (26) of the base member (20) define an acute included angle (A).

3. The press-on clip retainer (10) according to claim 2, wherein:
each of the rolled junction members (28) defines an apex of the acute included angle (A).

4. The press-on clip retainer (10) according to claim 3, wherein:
the wedge portion (52) of each tab member (40) and a corresponding one of the plurality of tab support members (26) of the base member (20) define an acute included angle of about 45°.

5. The press-on clip retainer (10) according to claim 1, wherein:
the wedge portion (52) of each tab member (40) and the plane P defined by the base member (20) define an acute included angle.

6. The press-on clip retainer (10) according to claim 5, wherein:
the wedge portion (52) of each tab member (40) and the plane P defined by the base member (20) define an acute included angle of about 45°.

7. The press-on clip retainer (10) according to claim 1, wherein each of the engaging members (64) has a straight shaped distal end (68).

8. The press-on clip retainer (10) according to claim 1, wherein each the tab member (40) includes on the affixing portion (62) thereof a plurality of engaging members (64) that project inwardly relative to the longitudinal axis L.

9. The press-on clip retainer (10) according to claim 1, wherein each the tab member (40) is inverted V-shaped.

10. The press-on clip retainer (10) according to claim 1, wherein the tab members (40) expand as the retainer is pressed onto the associated threaded fastener (12) and the engaging members (64) preclude pulling the retainer (10) off from the associated threaded fastener (12).

11. The press-on clip retainer (10) according to claim 1, wherein the tab members (40) expand as the retainer (10) is pressed onto the associated threaded fastener (12) and the retainer (10) can be rotated counterclockwise to remove the retainer (10) from the threaded fastener (12).

12. The press-on clip retainer (10) according to claim 1, wherein the plane P defined by the base member 20 is substantially perpendicular with the longitudinal axis L.

13. A press-on clip retainer (10) adapted to receive an associated threaded fastener (12), the retainer comprising:
a base member (20) defining a plane P and an opening (30) allowing for selective passage of the associated fastener (12) through the opening (30) along a longitudinal axis L of the clip (10); and
a plurality of tab members (40) coupled on proximal ends (50) thereof with the base member (20), each of the plurality of tab members (40) defining an affixing portion (62) configured to i) selectively lock on the associated fastener (12) responsive to relative motion between the affixing portion (62) and the associated fastener (12) in a first direction W, and ii) slide relative to the associated fastener (12) responsive to relative motion between the affixing portion (62) and the associated fastener (12) in a second direction I opposite from the first direction W,
wherein each of the plurality of tab members (40) defines a wedge portion (52) located between the proximal (50) and distal (60) ends thereof, the wedge portions (52) being angled radially inwardly relative to the plane P of the base member (20) and being configured to direct oblique forces F3, generated by selective movement between the clip (10) and the associated fastener (12) in the first direction W, along each tab member (40), the oblique force F3 having component forces comprising a radial inward force thereby pinching the fastener between the wedge portions (52) of the tab members (40).
